(19) United States
(12) Patent Application Publication
(10) Pub. No.: US 2012/0062062 A1
(43) Pub. Date: Mar. 15, 2012

(54) STATOR FOR A ROTATING ELECTRICAL MACHINE

(75) Inventors: Jean Claude Lienard, Felleries (FR); Brahim Ammar, Louvres (FR); Guy Legoix, Maubeuge (FR)

(73) Assignee: JEUMONT ELECTRIC, 59460 Jeumont (FR)

(21) Appl. No.: 13/259,261

(22) PCT Filed: Mar. 23, 2010
(86) PCT No.: PCT/FR2010/050528

§ 371 Date: Dec. 2, 2011

(30) Foreign Application Priority Data
Mar. 24, 2009 (FR) 0951889

(51) Int. Cl. H02K 5/04

(52) U.S. Cl. 310/91

(57) ABSTRACT

A stator for a rotating electrical machine, includes a housing including an outer casing and two end plates, a lantern ring made of a stack of magnetic plates supported by a frame made of flanges connected by bars; wherein the housing includes intermediate plates that are semicircular in shape and which form a cradle that is capable of supporting the lantern ring, the flanges are semicircular in shape and adapted so as to match the semicircular shape of the intermediate plates of the housing, when the lantern ring is placed inside the housing, the flanges including an upper part that has two vertical parallel edges that can be rigidly attached to the outer casing of the housing.

The present invention relates to the field of rotating electrical machines comprising a stator assembly and a rotor assembly, the rotor assembly pivoting with relation to the stator assembly around an axis of rotation.

More particularly, the present invention relates to a stator for a medium or high power electrical machine.

In general, stator designates the fixed assembly of the electrical machine formed by a housing and a wound magnetic circuit.

The magnetic circuit is formed by a stack of magnetic plates held pressed by a frame formed of two plates interconnected by bolts or welded flat parts, the assembly forming a lantern ring that is introduced in the housing.

A coil winding, formed of several insulated copper coils, is then introduced in the slots formed by the stack of magnetic plates, the coil winding of the lantern ring thus forming the stator winding.

In general, the housing of a medium or high power electrical machine is a welding structure made of steel plates capable of protecting the electrical machine and conducting to cooling air in the electrical machine.

The housing is formed by an assembly of thick end plates, on the order of 30 to 40 mm, connected by plates constituting an outer casing, the housing may be trussed by beams or columns of high mechanical rigidity.

The housing also comprises horizontal footings used as plates for fixing the housing on the floor, or a clamp for assembling the housing along a vertical axis.

The outer casing of the housing comprises openings for the input and output of coolant and is designed to receive one or more terminal boxes.

The housing generally has a parallelepiped shape and its ends are closed by end plates supporting the rotor assembly.

Stators for rotating electrical machines are known in which the lantern ring is introduced into the housing by passing the lantern ring through openings present in the end plates of the housing, the housing being placed along a vertical axis.

However, the placement and positioning of the lantern ring in this type of housing are operations requiring significant steps of handling and complex welding between the lantern ring and the housing, particularly with steps of turning the stator assembly to complete the welding.

In addition, the vertical positioning of the housing requires a significant deck height, notably in the case of the assembly of very long electrical machines.

In order to remedy these complex assembly problems, stators whose housings are formed by a casing comprising several elements have been developed: A first lower part covered by an upper cover in order to enable the introduction of the lantern ring in the housing placed horizontally in the lower part. In general, the lower part is 2 to 3 times thicker than the upper cover in order to support the rotor.

In this type of stator, the hosing is placed horizontally and the lantern ring is introduced by the upper face of the lower part, before the placement of the cover.

However, this type of assembly requires complex designs for housings formed by several elements and lantern rings, and also requires an adjustment operation for the horizontal positioning of the lantern ring when it is placed in the housing.

In fact, the lantern ring and the housing are generally connected by screwing and/or welding of plates, necessarily welded beforehand on the frame of the lantern ring and that rest on lugs to fix the housing to the floor.

In this context, the invention aims to remedy, these disadvantages by proposing a stator for an electrical machine with a simple and economical design enabling rapid assembly of the lantern ring in the stator housing, while eliminating centering operation of the lantern ring in the housing.

For this purpose, the invention proposes a stator for a rotating electrical machine comprising:
a housing comprising an outer casing and two end plates;
a lantern ring formed by a stack of magnetic plates maintained in a frame formed by flanges connected by bars;
   said stator being characterized in that
said housing comprises semicircular shaped intermediate plates forming a cradle capable of supporting said lantern ring;
said flanges are of a semicircular shape adapted so as to match the semicircular shape of said intermediate plates of said housing, when said lantern ring is placed in said housing, said flanges comprising an upper part presenting two vertical parallel edges that can be rigidly attached to said outer casing of said housing.

Thanks to the invention, it is possible to easily place and position the lantern ring in the housing, while eliminating significant handling and an operation to center the lantern ring in the housing.

The stator, according to the invention, enables the lantern ring to be centered when the lantern ring is placed in the housing without an additional adjustment step. The lantern ring is centered by means of the complementary semicircular shapes of the lantern ring flanges and intermediate plates of the housing.

The stator, according to the invention, also proposes a housing with a simple design formed by a single element supporting the lantern ring as well as a refrigeration system.

The stator for a rotating electrical machine according to the invention may also present one or more of the characteristics below, considered individually or according to all technically possible combinations:
said housing comprises an outer casing formed by two lateral walls and by a lower wall, said walls being arranged such that they form a U-shaped panel;
said outer casing comprises means to rigidify said outer casing;
said outer casing comprises means to rigidify said outer casing, said means being formed by a double fold of material or by a U profile, at the level of the upper part of the lateral plates;
said means to rigidify said outer casing support a refrigeration system for said stator;
said housing comprises a framework capable of rigidifying said housing;
said framework comprises means to rigidify said framework formed by a U-profile;
said upper part of said flanges is rectangular;
said upper part is rigidly attached by broaching;
said housing comprises at least two intermediate plates and said lantern ring comprises at least two lateral flanges.

Other characteristics and advantages of the invention will more clearly emerge from the description given below, for indicative and in no way limiting purposes, with reference to the attached figures, among which:

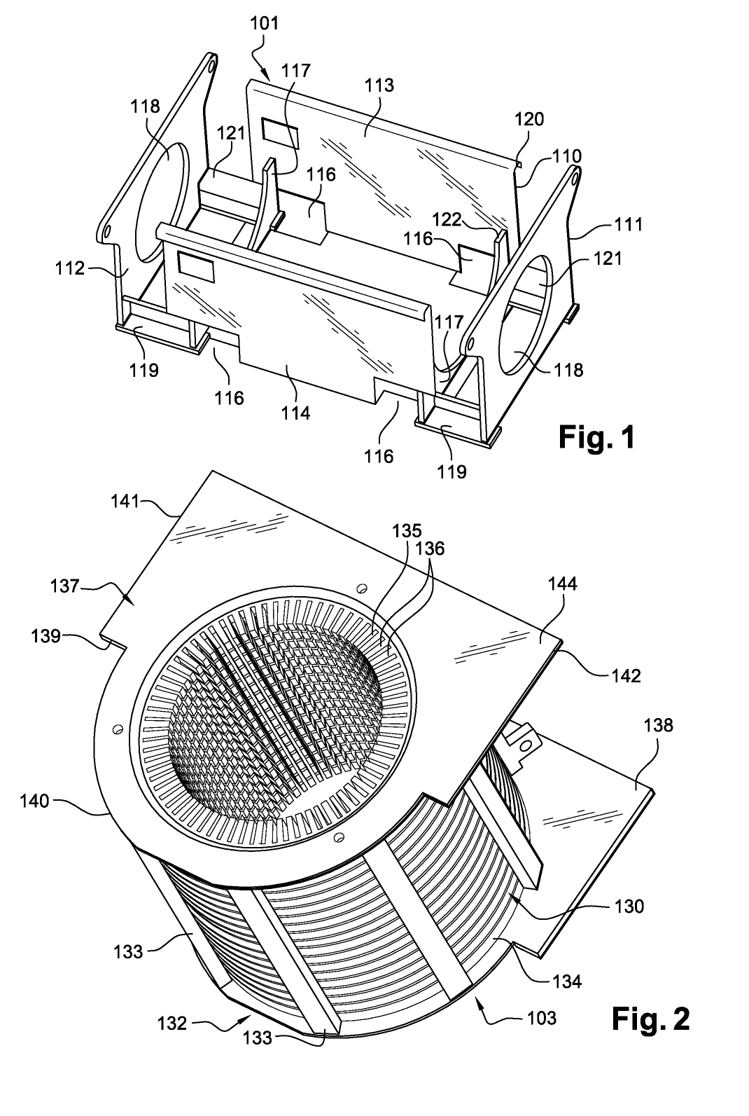

FIG. 1 is a blow-up view in perspective illustrating a stator housing for an electrical machine according to the invention;

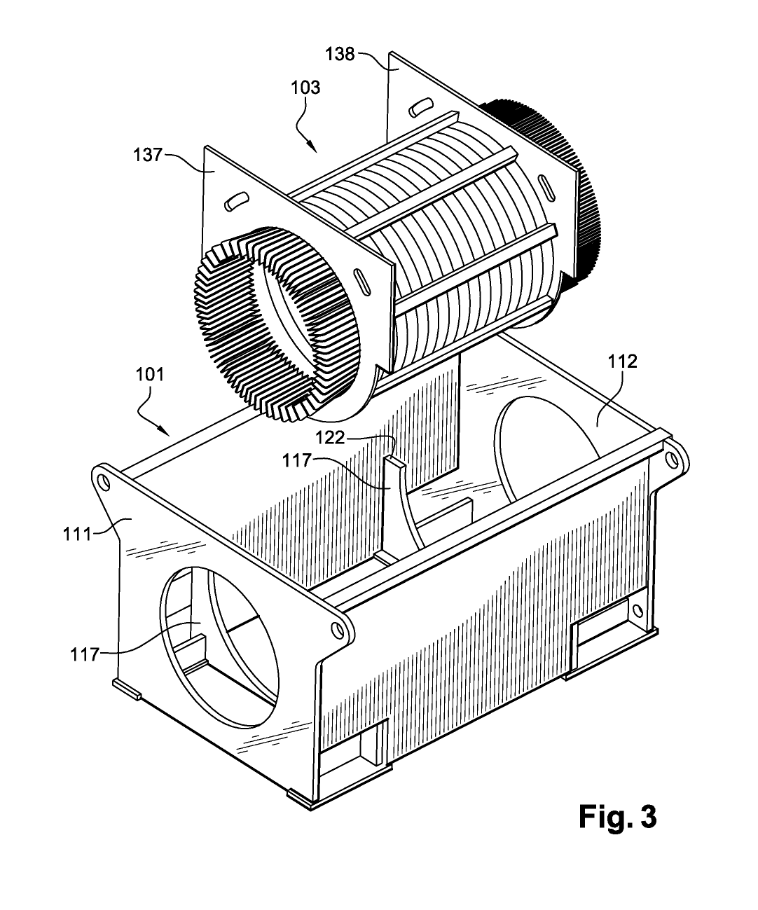

FIG. 2 is a perspective view of a lantern ring of an electrical machine stator according to the invention;

FIG. 3 is a perspective view before assembly of the stator formed by the housing illustrated in FIG. 1 and by the lantern ring illustrated in FIG. 2;

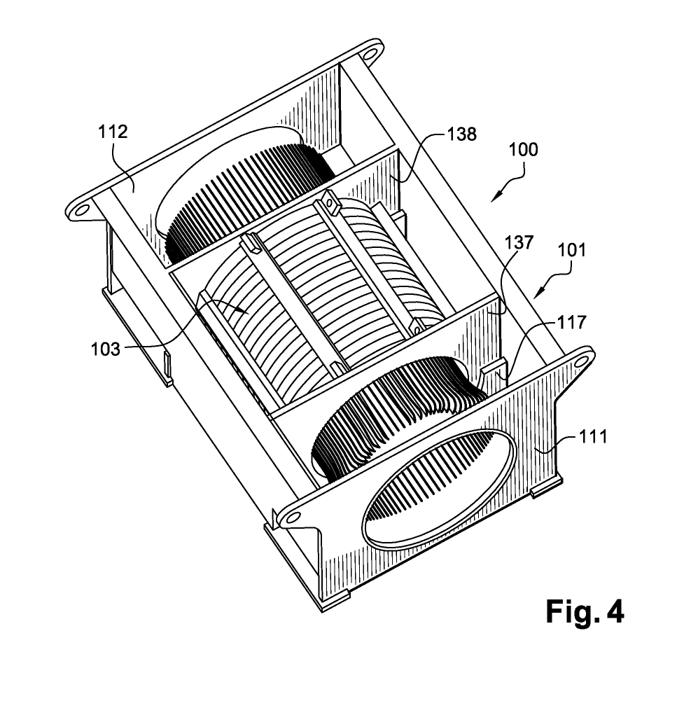

FIG. 4 is a perspective view of the stator illustrated in FIG. 3 assembled.

In all figures, common elements bear the same reference numbers, unless otherwise indicated.

FIG. 1 represents a blow-up view in perspective of a housing 101 of a stator 100 of an electrical machine according to the invention.

Housing 101 is formed by a U-shaped panel 110 constituting the outer casing of the housing 101, bordered on each end by an end plate 111, 112.

Panel 110 is formed by a U-folded plate comprising two vertical lateral walls 113, 114.

The panel 110 is notched at the four corners of its lower part so as to form openings 116.

End 120, of the upper parts of lateral walls 113, 114, comprises a return of material formed by a U-shaped double fold directed towards the exterior of the housing 101.

The U-shaped double fold notably enables the upper parts of the lateral walls 113, 114 of the housing 101 to be rigidified without interfering to the introduction of a lantern ring 103 by the upper part of the housing 101, the axis of the housing being positioned horizontally.

End plates 111, 112 border the ends of the panel 110 and comprise circular openings 118 capable of introducing and supporting a rotor (not represented) through bearings (not represented) integral with the end plates 111, 112.

The end plates 111, 112 are rigidly attached to the panel 110 by welding.

Housing 101 also comprises in its lower part, fixing lugs formed by horizontal footings 119 and by folded plates 121, the footings 119 comprising holes for the fixation of the housing 101 to the floor.

Footings 119 are arranged such that they are introduced in the openings 116 of the housing 110 during assembly of the end plates 111, 112 on the housing 110 by welding; The footings 119 being welded to the end plates 111, 112 and to the housing 110.

Housing 101 also comprises two intermediate plates 117, in a semicircular shape, arranged parallel to the end plates 111, 112 by a distance substantially equivalent to the length of the footings 119, the intermediate plates 117 being rigidly attached to the footings 119 and to the panel 110 by welding.

The external walls of the intermediate plates 117 are rigidly attached by welding to the lateral walls 113, 114 of the panel 110 so as to participate in the rigidification of the housing 101.

Thus, the intermediate plates 117 form in the housing 101 a cradle capable of receiving and positioning a lantern ring 103 for a rotating electrical machine.

FIG. 2 is a perspective view of the lantern ring 103 of the stator 100 for an electrical machine according to the invention.

Lantern ring 103 comprises a stator magnetic circuit 130 formed by a stack of magnetic plates disposed between two flanges 137, 138 interconnected by a plurality of bars 133.

The bars 133 are in rectilinear shape, the longitudinal axis of the bars 133 being parallel to the axis of rotation of the rotor, and hold the flanges 137, 138 so as to maintain the stack of magnetic plates in axial compression.

The stack comprises a succession of packs of magnetic plates 134 separated by ventilation vents. Each of the packs are formed by a plurality of identical conjoined steel magnetic plates.

Each magnetic plate is made by cutting and comprises, on its inner radial side, slots 135 formed between teeth 136, the slots 135 being configured to receive the coil winding of the stator (not represented).

Flanges 137, 138 comprise an upper part 144 with a rectangular shape and a lower part 140 with a semicircular shape.

The borders joining the rectangular upper part 144 to the semicircular lower part 140 form two shoulders 139 that are capable of being placed opposite the upper surfaces 122 of intermediate plates 117 in order to separate the ventilation zones of the stator and prevent air passages.

FIG. 3 is a perspective view before assembly of the stator assembly formed by the housing 101 illustrated in FIG. 1 and by the lantern ring 103 illustrated in FIG. 2.

FIG. 4 is a perspective view of the stator assembly after assembly.

In FIGS. 3 and 4, the lantern ring 103 is represented with the stator coil winding diagrammed.

Lantern ring 103 in horizontal position is assembled by the upper face of the housing 101 without a cover.

Horizontal position of the lantern ring is understood to refer to a position in which the axis of revolution of the stator is positioned more or less horizontally.

Positioning of the lantern ring 103 in the housing 101 is carried out by placing the lower part 140 of flanges 137, 138 on the intermediate plates 117. The semicircular shape of the lower part 140 of flanges 137, 138 is arranged to match the semicircular shape of the intermediate plates 117, such that the semicircular shape of flanges 137, 138 is complementary to the semicircular shape of the intermediate plates 117 of the housing 101.

The contact between these two semicircular, shapes thus ensures coaxiality between the lantern ring 103 and the housing 101.

The semicircular shapes of intermediate plates 117 and flanges 137, 138 thus enable the lantern ring 103, particularly the stator magnetic circuit, to be easily and quickly centered in the housing 101.

The positioning of flanges 137, 138 on intermediate plates 117 also enables the magnetic plates to be immobilized in rotation, as well as the lantern ring 103 to be immobilized in translation by broaching the flanges 137, 138 on housing 101, by means for example of pins, after the lantern ring 103 is placed.

Broaching of flanges 137, 138 on panel 110 by means of pins also enables the vibration transmission between the housing 101 and the lantern ring 103 to be dampened and limited.

Thus, the object of the invention is the production of a stator for a rotating electrical machine constituted of a housing and a lantern ring, of simple design, facilitating the centering and immobilization of the lantern ring in the housing and enabling the lantern ring to be placed in the housing in a simple and quick manner.

First, placement of the lantern ring is simplified by introducing the lantern ring in the housing by its upper face, the axis of the housing being positioned horizontally.

Subsequently, assembly of the lantern ring is simplified by the special design of the intermediate plates and by the flanges of the lantern ring, the intermediate plates forming a cradle that is capable of supporting and quickly centering the lantern ring equipped with complementary semicircular shaped flanges.

Producing the housing in one piece is enabled by the specific double fold shape of the upper part of the lateral walls, thus rigidifying the structure of the housing and enabling a refrigeration system to be placed.

Thus, the stator according to the invention proposes a housing and a lantern ring, with a simple design, enabling, first, difficulties with lantern ring handling and welding to be eliminated and, second, difficulties with designing and centering the lantern ring in the housing to be eliminated.

The housing of the stator according to the invention is a supporting structure formed of a single piece comprising upper reinforcing elements enabling a refrigeration system to be supported while eliminating the presence of a cover.

A stator for an electrical machine comprising a housing formed by a U-folded plate making the outer casing of the housing has essentially been described, however, the outer casing of the housing may also be replaced by a framework connecting the two end plates and comprising a reinforcing element in its upper part and at least one connecting element to rigidly attach the two end plates.

Another object of the invention is a method of assembling a lantern ring in a housing comprising the steps consisting of:
positioning the housing flat such that the axis of revolution of the stator is positioned horizontally;
lowering the lantern ring in the horizontal position in the housing until the semicircular shapes of the intermediate plates and flanges are in contact;
broaching flanges on the housing such that the lantern ring is immobilized in the housing.

The invention described is equally applicable to synchronous or asynchronous rotating machines.

Other advantages of the invention are, in particular, as follows:
reduced production costs of the stator;
reduced assembly time of the stator;
facilitated industrial production; improved stator cooling, particularly connected to producing the housing in one piece;
simplified housing design, particularly by producing the housing in one piece;
better holding of bearings by the end plates.

1. A stator for a rotating electrical machine comprising:
a housing comprising an outer casing and two end plates;
a lantern ring formed by a stack of magnetic plates maintained in a frame formed by flanges connected by bars;
wherein said housing comprises semicircular shaped intermediate plates forming a cradle capable of supporting said lantern ring; and
wherein said flanges are of a semicircular shape adapted so as to match the semicircular shape of said intermediate plates of said housing when said lantern ring is placed in said housing, said flanges comprising an upper part presenting two vertical parallel edges that can be rigidly attached to said outer casing of said housing.

2. The stator for a rotating electrical machine according to claim 1, wherein said outer casing is formed by two lateral walls and by a lower wall, said walls being arranged such that they form a U-shaped panel.

3. The stator for a rotating electrical machine according to claim 1, wherein said outer casing comprises means to rigidify said outer casing.

4. The stator for a rotating electrical machine according to claim 2, wherein said outer casing comprises means to rigidify said outer casing, said means being formed by a double fold of material or by a U profile at the level of the upper part of the lateral plates.

5. The stator for a rotating electrical machine according to claim 3, wherein said means to rigidify said outer casing support a refrigeration system for said stator.

6. The stator for a rotating electrical machine according to claim 1, wherein said housing comprises a framework capable of rigidifying said housing.

7. The stator for a rotating electrical machine according to claim 6, wherein said framework comprises means to rigidify said framework formed by a U-profile.

8. The stator for a rotating electrical machine according to claim 1, wherein said upper part of said flanges is rectangular.

9. The stator for a rotating electrical machine according to claim 8, wherein said upper part is rigidly attached by broaching.

10. The stator for a rotating electrical machine according to claim 1, wherein said housing comprises at least two intermediate plates and said lantern ring comprises at least two lateral flanges.
